(19) United States
(12) Patent Application Publication
(10) Pub. No.: US 2026/0019836 A1
(43) Pub. Date: Jan. 15, 2026

(54) EMERGENCY MODE FOR NETWORKED DEVICES

(71) Applicant: AVI-On Labs, LLC, Park City, UT (US)

(72) Inventors: Eric L. Miller, Jr., Park City, UT (US); Keenan McCall, Hood River, OR (US); Federico Pfaffendorf, Buenos Aires (AR)

(21) Appl. No.: 18/771,983

(22) Filed: Jul. 12, 2024

(51) Int. Cl. H04W 24/06; H05B 47/16

(52) U.S. Cl. CPC H04W 24/06; H05B 47/16

(57) ABSTRACT

Systems and methods for managing an emergency mode of operation in a network system having network components in a many-to-many, peer-to-peer network. The network components include emergency beacons, emergency-enabled controlled devices, and normal power devices. In an emergency test mode of operation, the normal power devices disable their peer-to-peer forwarding functionality, such that these devices do not forward messages during a subsequent trigger of emergency state. Subsequently, the emergency beacons trigger an emergency mode of operation in the emergency-enabled controlled devices.

### BACKGROUND

In structures such as houses and high-rise buildings, there may be many components (e.g., switches and sensors) configured to control target devices (e.g., fixtures and appliances), using adaptors communicatively coupled to the target devices. When these components are coupled to transceivers, they may be formed into a flexible wireless mesh communications network that provides seamless control of target devices based on signals transmitted from the switches and sensors to the adaptors. Other network components, such as initialization/control (I/C) devices and/or bridge devices, which enable a user to set up and control the various network components locally or remotely, may also be included in the communications network.

In many jurisdictions, buildings larger than a certain minimum size must comply with regulations and ordinances, such as UL 924 or UL 1008, that may require certain power or lighting behavior for safety reasons. For example, a local regulation might require buildings to turn exit pathway lighting on 100% during emergency conditions. This is typically accomplished by having a local backup power source, such as batteries or a generator, connected to a dedicated emergency lighting circuit. Sometimes, in scenarios with individual fixture control, this can be accomplished by installing emergency-specific fixtures with integrated backup batteries. However, recent updates to regulations have changed how emergency lighting works in significant ways. These changes are further challenged by the emerging popularity of lighting fixtures that are communicatively coupled to form communication networks. As such, there is a need for improved emergency-compliant operations of networked devices.

### SUMMARY

Embodiments of the inventive concepts disclosed herein are directed to systems, protocols, and methods for managing and testing an emergency mode of operations in facilities with large-scale distributed mesh networks employing short-range communications protocol(s). Embodiments include an emergency beacon device that is configured to continuously detect the presence/absence of normal power and, if absent, signals one or more controlled devices (e.g., emergency fixtures) via short-range communications to turn on (and override any dimming commands) until normal power is restored.

According to some embodiments, a network system includes a plurality of network components, which include at least one emergency beacon device and a plurality of adapters. Each network component includes a transceiver configured to send and receive control signals via a short-range wireless communications protocol, a memory storing an emergency test mode status, and a central processor configured to execute instructions stored in the memory. At least one target device is communicatively coupled to each adapter. An emergency control signal broadcast from the emergency beacon(s) device is received by each network component within range of the emergency beacon device via the short-range wireless communication protocol, rebroadcast by a first subset of the network components, and not rebroadcast by a second subset of the network components.

In some embodiments, that first subset of network components are UL924-enabled devices. In some embodiments, that second subset of network components are normal power devices. In some embodiments, the second subset of network components is configured to disable mesh forwarding functionality responsive to receiving an emergency test mode control signal. In some embodiments, the second subset of network components is configured to exit emergency test mode based on the expiry of a timer. In some embodiments, the second subset of network components is configured to restart the timer responsive to receiving a control signal retriggering emergency test mode. In some embodiments, the emergency beacon device is configured to stop broadcasting the emergency control signal responsive to the expiration of a test mode timer.

According to an embodiment of the present disclosure, a method for operating a network system, comprising an initialization/control device, an emergency beacon device and a plurality of adaptors, and at least one target device communicatively coupled to each adaptor. The method includes generating and broadcasting, from the initialization/control device, an emergency test control signal to the plurality of adaptors, and determining, by each of the plurality of adaptors, whether the respective adaptor is emergency-enabled. The method further includes disabling, by a first subset of the plurality of adaptors, mesh forwarding functionality of the respective adaptor responsive to determining that the respective adaptor is not emergency enabled, and generating and broadcasting, from the emergency beacon device, an emergency control signal to the plurality of adaptors. The emergency control signal is not rebroadcast by the first subset of adaptors. The method includes operating each emergency-enabled adaptor in an emergency mode of operation responsive to the adaptor receiving the emergency control signal.

According to an embodiment of the present disclosure, a method for operating a network system includes providing the network system, including an initialization/control device, a lockdown beacon device, a plurality of adaptors, and at least one target device communicatively coupled to each adaptor. The method includes generating and broadcasting, from the lockdown beacon device, a lockdown control signal to the plurality of adaptors, and responsive to receiving the lockdown control signal, by each adaptor, operating the respective adaptor in a lockdown mode of operation.

In some embodiments, the lockdown mode of operation comprises modifying a dimming level of a target device based on a predetermined lockdown level. In some embodiments, the lockdown mode of operation comprises modifying a motion control timer of a target device based on a predetermined lockdown level. In some embodiments, the lockdown mode of operation comprises disabling modification of a dimming level and/or a motion control timer.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 depicts a schematic diagram of a network system for controlling target devices, in accordance with some embodiments;

FIG. 2 shows schematic views of an emergency beacon device and a controlled device, in accordance with some embodiments;

FIG. 3 depicts a schematic diagram of another network system for controlling and testing target devices in emergency modes of operation, in accordance with some embodiments;

FIG. 4 is a flowchart of an exemplary method for implementing an emergency test mode of operation in the distributed mesh network of FIGS. 1 and 3, in accordance with some embodiments;

FIG. 5 is a flowchart of an exemplary method for implementing a lock test mode of operation in the distributed mesh network of FIG. 1, in accordance with some embodiments.

### DETAILED DESCRIPTION OF THE DISCLOSURE

In the following description, several specific details are presented to provide a thorough understanding of embodiments of the inventive concepts disclosed herein. One skilled in the relevant art will recognize, however, that embodiments of the inventive concepts disclosed herein can be practiced without one or more of the specific details, or in combination with other components, etc. In other instances, well-known implementations or operations are not shown or described in detail to avoid obscuring aspects of various embodiments of the inventive concepts disclosed herein.

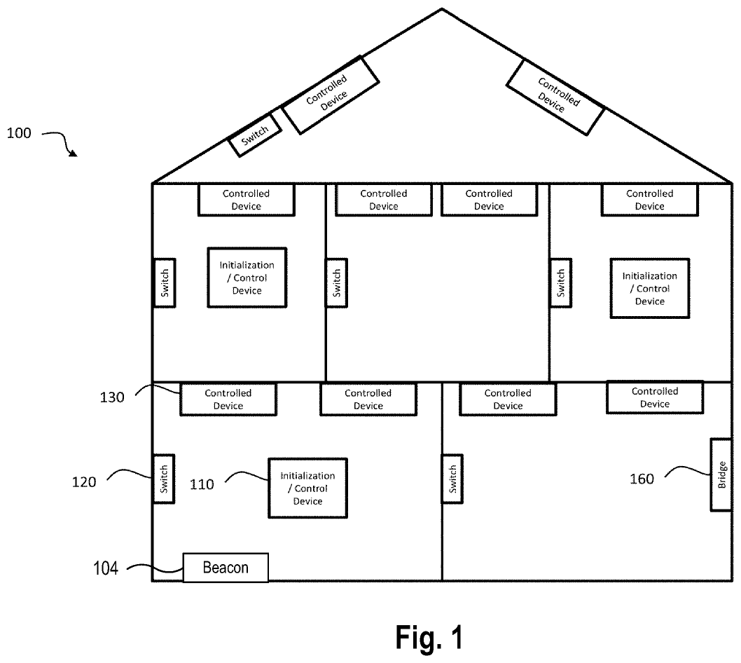

FIG. 1 depicts a schematic diagram of network system 100 for controlling target devices, in accordance with some embodiments. Network system 100 may include one or more initialization/control (“I/C”) devices 110, switches 120, controlled devices 130, and bridges 160. Network system 100 may be installed in any suitable fixed or moveable structure, such as a residential or commercial building, a tent, or a trailer, for example. I/C devices 110, switches 120, adaptors, which may be part of controlled devices 130, and bridges 160 may be referred to herein as “network components.” Other examples of such communication networks were disclosed in the following publications: U.S. Pat. No. 9,781,245 entitled “Networking Systems, Protocols, and Methods for Controlling Target Devices” and issued to Miller on Oct. 3, 2017; and U.S. Pat. No. 10,237,391 entitled “Networking Systems, Protocols, and Methods for Controlling Target Devices” and issued to Miller on Mar. 19, 2019, each of which is incorporated herein in its entirety.

According to some embodiments, I/C devices 110 may serve dual functions in network system 100. First, I/C devices 110 may be used to configure all of the components of network system 100 (e.g., switches 120, adaptors in controlled devices 130, bridges 160, and other I/C devices 110). A user may interact with computer programs running on one or more of I/C devices 110 to define desired system functionality, such as defining which switches 120 control which controlled devices 130, defining automatically scheduled behaviors for controlled devices 130, and so on.

Second, I/C devices 110 may be used as system controllers for controlling all or a subset of the various system components. Accordingly, a user interacting with a computer program installed on I/C devices 110 may be able to control individual switches 120 and/or individual controlled devices 130. In some embodiments, a user may interact with a user interface provided by the computer program to send commands to selected switches 120 and/or individual controlled devices 130. I/C devices 110 may facilitate control of various control functions as appropriate for the type of controlled device or devices present in network system 100.

Examples of electronic devices that may be used as I/C devices 110 may include any suitable type of electronic device operative to communicate with switches 120 and controlled devices 130. For example, I/C devices 110 can include digital media players, cellular telephones, smartphones, pocket-sized personal computers, personal digital assistants (PDAs), tablets, desktop computers, laptop computers, and/or any other suitable electronic device.

Communication between I/C devices 110 and switches 120 and/or controlled devices 130 may be implemented over the protocols described herein and/or over any other suitable wired or wireless interface, such as via Wi-Fi® (e.g., a 802.11 protocol), Ethernet, Bluetooth®, radio frequency systems (e.g., 900 MHz, 2.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), other relatively localized wireless communication protocol, or combinations thereof. In some embodiments, communications may be conducted over combinations of wired and wireless paths. I/C devices 110 may communicate directly with switches 120 and controlled devices 130 or indirectly via an intermediary device such as a Wi-Fi® router, for example. Communications components provided within I/C devices 110, switches 120, controlled devices 130, and bridges 160 may be referred to herein as “transceivers” regardless of the particular mode or modes of communication used to implement the communications.

Switches 120 may be provided within network system 100 to sense user input and translate the input into a control signal for implementation by one or more controlled devices 130. The control signal may be transmitted via a switch transceiver. The type of control signal(s) generated by a particular switch may depend on the controlled devices 130 the switch is configured to control. In the simplest case, a switch may be configured to toggle a state (e.g., turn on or off) of one or more controlled devices 130. Thus, in some embodiments switches 120 may include one or more wall-mounted light switches configured to turn one or more lights on and off. Switches 120 may also include more complex switches, such as light dimmers, fan controllers, thermostat controllers, appliance controllers, and/or entertainment system controllers, for example.

These more complex switches may utilize physical control elements (e.g., dials, sliders, and/or buttons) and/or virtual control elements (e.g., onscreen user interface elements) to generate control signals directed to one or more particular controlled devices 130.

In some embodiments, switches 120 may be powered by one or more power sources external to the structure's fixed, high-voltage electrical system, such as batteries, for example. Physically decoupling switches 120 from the structure's electrical system may beneficially allow for these physical components, which are often very difficult to move, to be placed in any convenient locations throughout the structure. Furthermore, adding additional switches to network system 100 may simply involve placing the additional switches within range of network system 100 and configuring the additional switches to control one or more controlled devices 130.

It should be understood that existing switches already hardwired into a structure's existing electrical system may be configured to control controlled devices 130 while continuing to be powered by the building's electrical system. Such hardwired switches may be retrofitted with transceivers that facilitate communications between switches 120, controlled devices 130, bridges 160, and I/C devices 110. In these embodiments, some minor re-wiring of controlled devices 130 and switches 120 may be necessary to bypass the traditional hardwired switching functionality and provide constant, non-switched power to the switch.

Controlled devices 130 may include two main components, a target device and an adaptor. As discussed above, the target device may be any suitable electrical or electronic device capable of being controlled. An adaptor may include various components for receiving and implementing control signals generated by I/C devices 110 and/or switches 120. For example, an adaptor may include a transceiver for receiving control and/or initialization signals from I/C devices 110 and/or switches 120, a central processor, a memory, an antenna, a line power switch and/or a dimming circuit, one or more sensors (e.g., heat sensors, motion sensors), and a control output interface for implementing complex control commands (e.g., speed control, motion control, or other complex commands).

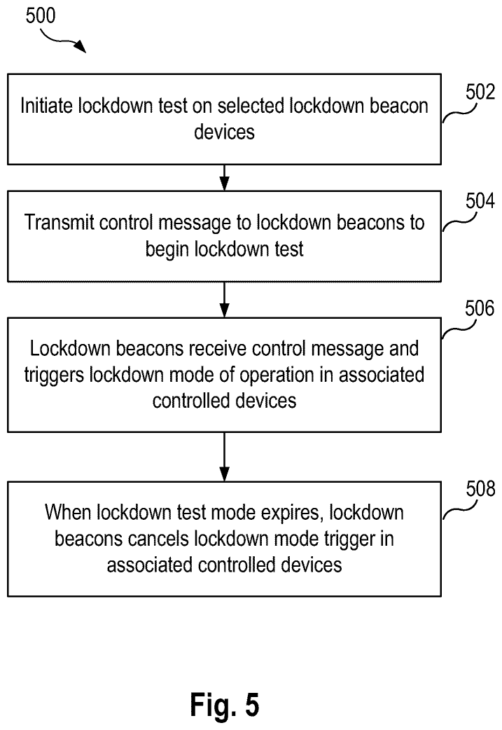

Instructions may be stored in the adaptor's memory that define various settings and behaviors. For example, the instructions may define which I/C devices 110 and/or switches 120 the adaptor should respond to, automated control schedules, and/or other behaviors. The instructions may be loaded into the adaptor's memory during an initialization process, as described in detail below with respect to FIGS. 5 and 9.

Bridge 160 can provide a remote interface to network system 100 to enable remote operation of the network's various network components. In this manner, network system 100 may be accessed and controlled even if I/C devices 110 are out of range without the need for a central controller. No central controller is necessary for remote control of network system 100 because bridge 160 can be configured as yet another network component, like switches 120 and controlled devices 130, for example.

Accordingly, bridge 160 can provide access to network system 100 as a network component of the network, not as a gateway or central access point.

Bridge 160 can, therefore, be a low-cost, simple device configured to relay messages between network system 100 and a remote server. Generally speaking, bridge 160 can: permit remote visibility, via a remote device, of the current status of the various configured network components even while the remote device is out of range of network system 100; issue commands to network system 100 via the remote server and bridge 160 to monitor and/or change the status of one or more network components; and/or send a set of commands to a range of network components. Examples of functions that might not be permitted when accessing network system 100 via bridge 160 (e.g., to promote network security) may include: adding, deleting, or authenticating network components; updating usernames, passwords, or security keys; obtaining MAC addresses of network components; and creating or modifying network component groups or scenes. Scenes may generally be understood as pre-set control settings for one or more controlled devices 130 (e.g., turn on all kitchen lights and the coffee maker at 6 AM, dim all living room lights at 8 PM, or preheat oven and turn on stereo at 5 PM).

Bridge 160 can include a transceiver that enables communications between every other network using the protocol established for the network. Via the transceiver, bridge 160 can have visibility to all of the network components of network 100, including, for example, the address of each network component and its functionalities (e.g., whether the component is a switch or controlled device, which other components are a particular component controls or responds to, etc.). Additionally, bridge 160 may be connected or connectable to a remote server via an outside network (e.g., the Internet) using a wired or wireless interface, such as one or more of the interfaces listed above, for example.

A remote device may then connect to the remote server to gain access to network system 100 via bridge 160. When the remote device connects to the remote server, commands directed to network system 100 can be relayed through the remote server to the interface of bridge 160. Because bridge 160 is secured to network system 100 during the initialization process, further security for bridge 160 may not be required. The remote server can be secured against unauthorized access using authentication procedures known in the art (e.g., passwords, two-factor authentication, etc.). Bridge 160 may be configured to connect to a router that facilitates communications to the remote server, which configuration may entail providing the bridge with security credentials to log into the remote server.

Bridge 160 may further include a central processor and a memory for storing instructions that can define its role in network system 100. For example, the instructions may define an interface for providing a remote device with access to the other network components of network system 100. Accordingly, the memory may store a database containing the relationships between the various network components, such as which switches 120 are configured to control which controlled devices 130, for example, and allow operation of switches 120 and controlled devices 130. The instructions may be loaded into the adaptor's memory during an initialization process.

The interface can grant a remote device access to network system 100 through bridge 160. In order to maintain the security of the network, however, the functionality of the interface may be limited only to accessing information that was previously defined during an initialization process. In this manner, a remote user may be permitted to connect to bridge 160 through the remote server and operate switches 120 and/or controlled devices 130 per the configuration data stored in the database of bridge 160. That is, while network components of network system can be controlled remotely, a remote user may be prevented from altering the configuration of network system 100 using bridge 160. Because bridge 160 can be configured during an initialization process by an account holder authorized to configure the network and bridge 160 must be within range of the network to operate, it may not be necessary for the device to have separate security access or to be granted security keys for the network. Remote access to network system 100 may, therefore, be permitted far more cheaply and easily than in systems that require a central controller or another non-network component device to facilitate remote access.

In some embodiments, bridge 160 can include a transceiver (e.g., a Bluetooth® transceiver) that facilitates communications with the other network components of network system 100 and a communications interface to a separate device (e.g., a PC, tablet, or laptop computer) capable of communications with the remote server via an outside network, such as the Internet, for example. As one particular example, bridge 160 may be implemented as a Universal Serial Bus (“USB”) “dongle” that can be connected to an Internet-connected device, such as the family computer, for example. These embodiments advantageously permit bridge 160 to be manufactured relatively cheaply because the connection to the remote service is facilitated using another network-connected device. However, in order to maintain access to the remote server, that network-connected device must remain powered-on and connected to the outside network. In another example, bridge 160 may include a second transceiver (e.g., a Bluetooth® transceiver) to facilitate communications with the separate device.

In an alternative implementation, bridge 160 can include both the transceiver for communicating with the other network components as well as the wired or wireless interface to the remote server via the outside network. Accordingly, remote access to network system 100 may not be dependent on the availability of a separate network-connected device. As one example, bridge 160 may be a standalone device that communicates with the other network components of network system 100 via a Bluetooth® transceiver and with the remote server via a Wi-Fi® connection or other suitable wired or wireless network connection (e.g., an Ethernet, 3G, or 4G LTE connection) to the Internet. In the event that bridge 160 is capable of Wi-Fi® communications, I/C devices 110 may be used to configure the Wi-Fi® connection. For example, bridge 160 may recognize a list of available Wi-Fi® networks, provide that list to I/C devices 110 (e.g., using the transceiver), and connect to a selected Wi-Fi® network by receiving authentication information (e.g., a password) from I/C devices 110.

In still further implementations, an existing network component of network 100, such as one of one or more of switches 120 or adaptors 140 (disclosed in detail below) or a generic gateway device, for example, may be configured to carry out the functionalities of bridge 160. In these embodiments, software or firmware may be installed on the existing network component in order to provide an interface to grant a remote device access to control network system 100. The network component that implements the bridge functionality can then communicate, using either the communications protocol of network system 100 or another suitable wired or wireless communications protocol (e.g., WiFi®) with a device having a wired or wireless interface to the remote server via the outside network, such as a generic gateway or router, for example.

According to an embodiment, the system 100 includes an emergency beacon device 104. Emergency beacon device 104 is configured to detect the conditions for triggering emergency modes within the system 100. For example, emergency beacon device 104 includes circuitry configured to detect the presence or absence of “normal power” to trigger emergency lighting modes among the network components of the system 100. In one aspect, emergency beacon device 104 is configured to transmit a wireless signal to an emergency control device wired with an emergency-enabled circuit load controller (e.g., XFAC).

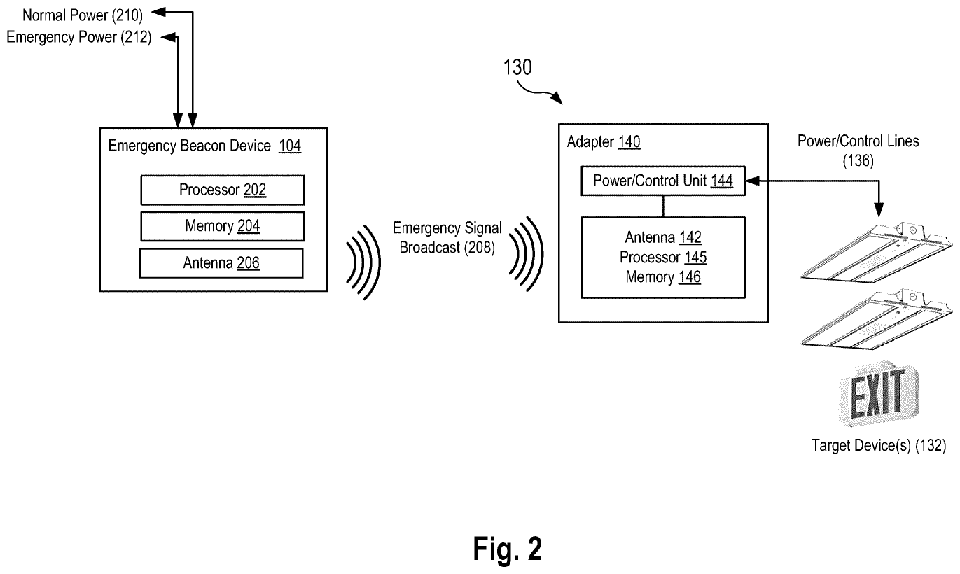

FIG. 2 shows a schematic view of controlled device 130 and emergency beacon device 104, in accordance with some embodiments. Controlled device 130 may include a target device 132 coupled to adaptor 140 with one or more power/control lines 136. Adaptor 140 may include antenna 142, which may be responsible for transmitting and/or receiving signals within a network system (e.g., network system 100 of FIG. 1), and power/control unit 144 for implementing control signals directed to target device 132.

In some embodiments, antenna 142 and other low-voltage components of adaptor 140, such as a processor and a memory, may be packaged separately from the high-voltage components housed in power/control unit 144. Packaging antenna 142 separately from the high-voltage components may prevent signal degradation caused by RF interference generated by target device 132, power/control unit 144, power/control lines 136, and/or any other high-voltage components of controlled device 130. Furthermore, the high-voltage components may be located inside a fixture (not shown) sized and shaped appropriately for target device 132. For example, when the target device is a recessed light, the fixture may be a can that may shield antenna 142, located outside of the fixture, from interference. Housing the high-voltage components of controlled device 130 within the fixture may support electrical safety certifications, improved visual concealment, and convenience, for example.

Power/control unit 144 may include a central processor for implementing control signals received at antenna 142. The central processor may be any suitable processing device, such as a microprocessor configured to perform operations based on the execution of software and/or firmware instructions or an ASIC that is configured to perform various operations, for example. Operations performed by the central processor may include retrieving data from and/or writing data to a memory of power/control unit 144. For example, during an initialization process, the central processor may receive instructions regarding an address, which control signals to implement, and/or automatically implemented scheduling instructions for controlled device 130. During operation, the central processor may access the information stored in the memory in order to implement control functions for target device 132.

Adaptor 140 may retransmit signals received at antenna 142 to enable the network system to operate as a peer-to-peer, many-to-many control system. That is, besides merely implementing control signals received at antenna 142, adaptor 140 (as well as all other network components of network system 100) may also rebroadcast received control signals to other components (e.g., other switches, adaptors, and bridges) of the network system. In this manner, the network system may operate using relatively short-range wireless signals, such as those used in the Bluetooth® protocol. In one embodiment, adapter 140 may receive emergency signals at antenna 142 from an emergency beacon 104 (described in greater detail below) and selectively retransmit the emergency control signal based on the emergency mode of operation.

Power/control unit 144 may include a physical circuit for implementing simple power control functions for target device 132. For example, if target device 132 is a light, power/control unit 144 may include a line power switch and/or a dimming circuit to facilitate on/off and dimming control of target device 132, respectively. For more complex target devices, power/control unit 144 may include a control output interface for implementing more complex control commands, such as changing color, fan speed, operating mode, etc. In some embodiments, power/control unit 144 may be a generic controller capable of controlling many different types of target devices. In other embodiments, however, a specialized power/control unit 144 may be provided that specifically implements only the types of control functions available for the coupled target device 132.

Power and control signals for a target device 132 (e.g., emergency lighting fixtures) may be generated within power/control unit 144 and sent to target device 132 via power/control lines 136. Power/control lines 136 may include one or more control lines for carrying control signals from power/control unit 144 to the target device, AC Line Out for carrying AC power from power/control unit 144 to the target device, AC Line In for receiving AC power from the structure's fixed electrical wiring system, and AC Common (Neutral) Line. Simple on/off or dimming control may be implemented within power/control unit 144 by varying the average power provided over AC Line Out. The power/control lines 136 may include power lines from normal power sources and/or from emergency backup power sources (e.g., backup generator or battery via dedicated emergency wiring from, or backup batteries integrated with the fixture) for use in emergency modes of operation. More complex control commands may be generated by central processor 145 carried over control lines 136 to a control interface of the target device. Any suitable number of individual control lines 136 may be provided to implement available control functionality of the target device.

In many jurisdictions, buildings larger than a certain minimum size must comply with regulations and ordinances, such as UL924 or UL1008, that may for example require that a building have exit pathway lighting turned on during emergency situations. This is typically accomplished by having a local backup power source, such as batteries or a generator that can be connected to a dedicated emergency lighting circuit. Sometimes, in scenarios with individual fixture control, this can be accomplished by installing emergency-specific fixtures with integrated backup batteries. On a loss of utility power, or some other trigger (e.g., from a life safety control system or a building control system), a UL1008-listed transfer switch disconnects the circuit from utility power and connects the backup source to the circuit. Battery-based emergency fixtures simply switch to their battery power source upon loss of normal power (and also block any lighting control signals from reaching the fixture output.)

With the recent updates to UL924, UL has changed how emergency lighting works in significant ways. In the past, a circuit level device would detect turn-on of emergency power and trigger the lights to stay on at full for 90 minutes, and be set to a non-bypassable status. Now, UL924 requires active and continuous detection of normal power. Emergency mode is now triggered by the loss of normal power, just for the duration of that power loss, rather than for a specified time frame (e.g., 90 minutes). Devices that passively detect either the presence of emergency power, or the interruption of normal power to trigger an emergency mode are no longer permitted.

These updated regulations for lighting emergency modes has raised issues about robustness and ease of use, particularly in situations involving network components described herein. Again, since a UL924 emergency mode trigger is no longer coming from an UL924-enabled device itself, but instead from a single or several UL924 beacons in the locations, it has been determined that users are concerned that when a genuine UL924 emergency situation occurs, the emergency powered fixtures might not form a complete communications mesh, and therefore might not all receive the UL924 emergency beacon message. Accordingly, there is a need for improved configurations and testing of emergency modes in network components.

According to aspects of the present invention, network components are provided with the ability to test an emergency mode set-up in real time. This testing may be done without having to resort to drastic triggers such as terminating normal power to an entire facility or building. In some embodiments, network components are configured to trigger an UL924 emergency mode on specific devices or groups of devices instead of being broadcast to the entire network. Many buildings and facilities use multiple transfer switches to manage emergency circuits for different areas of the building (e.g., different floors of the building). When normal power is lost in one area, users have the ability to only trigger a UL924 emergency mode in that particular area, instead of throughout the entire facility, according to an embodiment of the present disclosure. While aspects of the present disclosure are described in relation to the specific regulation UL924, it is understood that the scope of the described embodiments include other similar specifications and regulations for fixtures.

One or more network components (e.g., I/C devices 110, switches 120, controlled devices 130) are configured to operate in an emergency mode of operation. In one example, when operating in an emergency mode, one or more of the network components may be configured to provide emergency exit lighting and exit pathway lighting. The network components are configured to receive one or more control signal(s) that operatively enables or disables an emergency mode of operation for the network components. A network component may be wired into a dedicated emergency circuit control or may have an external antenna configured to receive emergency control signals from a beacon device.

According to an embodiment, one or more network components (e.g., I/C devices 110, switches 120, controlled devices 130) are configured to operate in an emergency test mode of operation. When the emergency test mode is enabled for a given network component, if that network component is in “normal power” mode, the network component is configured to not relay any mesh messages that it might receive from other network components in the communications mesh. In contrast, when a given network component that is an emergency-enabled device receives an enable/disable emergency test mode message, the device may ignore the message, thereby keeping enabled its mesh message relay functionality. This configuration enables the mesh network to test whether the emergency-powered fixtures can still form a complete mesh, thereby simulating the robustness of the mesh network in emergency modes of operation where less than the entire system might be operational.

In one aspect, the network component may be configured to remain in the emergency test mode for a configurable amount of time (e.g., 1 to 90 minutes). Upon expiry of such a timer, the network component is configured to revert its mesh message relay flag setting back to what it was before the emergency test mode was enabled. The network component is configured to reset or restart an active timer responsive to receiving a retriggering of the emergency test mode. In some embodiments, the network component may be configured to disable the emergency test mode with a mesh message.

FIG. 2 further shows a schematic view of an emergency beacon device 104, in accordance with some embodiments. The emergency beacon device 104 has a central processor 202 and memory 204, which may be housed with an antenna 206. In other embodiments, however, central processor 202 and/or memory 204 may be housed along with control circuitry in emergency beacon device 104 in order to give the housing for antenna 206 a smaller form factor. In some embodiments, antenna 206 communicatively coupled to and external to the emergency beacon device 104.

Emergency beacon device 104 may receive power from power/control lines 210, 212 from normal power sources or emergency power sources (e.g., batteries or backup generator delivering power via dedicated emergency wiring). The power lines may include AC Line In for carrying normal AC power from the structure's fixed electrical wiring system, and a second Line In for carrying AC power from the structure's separate emergency electrical wiring (dedicated to power emergency fixtures), which may originate from a backup generator or backup batteries. In some embodiments, the second Line In may carry battery power from a battery, e.g., an integrated battery.

In contrast to prior electrical standards, emergency beacon device 104 is a dedicated device configured to actively and continuously detect normal power within network system 100, and to notify other devices of an emergency condition of power loss. Emergency beacon device 104 is configured to detect an emergency state of power loss based on the power signals from power lines 210, 212. For example, emergency beacon device 104 may determine an emergency state of power loss based on a loss of normal power on power line 210 for a specified period of time (i.e., for the duration of the power loss). Responsive to determining an emergency state (of power loss), emergency beacon device 104 uses antenna 206 to transmit/broadcast an emergency signal 208 to one or more controlled devices 130. When received by an emergency-enabled (e.g., UL924-enabled) adapter 140, that emergency signal 208 triggers the operation of certain target devices 132 (e.g., turning on certain emergency lighting fixtures, turns off dimming), and can deactivate other target devices 132 (which are not emergency-enabled).

In one aspect, the emergency beacon device is also configured to operate in an emergency test mode of operation. When the emergency test mode is enabled, the emergency beacon device will trigger its current emergency configuration (e.g., UL924 configuration). In one embodiment, the emergency beacon device may be configured to store, maintain, and operate a timer representing a configurable timeout period for the emergency test mode (e.g., 1 to 90 minutes). Similar to the network components, any retrigger during an active timer restarts the timer on the beacon device. When the beacon device is taken out of emergency test mode (expressly by control signal, or by expiry of the timer), the beacon device is configured to transmit one or more control signals cancelling the emergency configuration (e.g., UL924 trigger) on its associated devices and/or groups of devices.

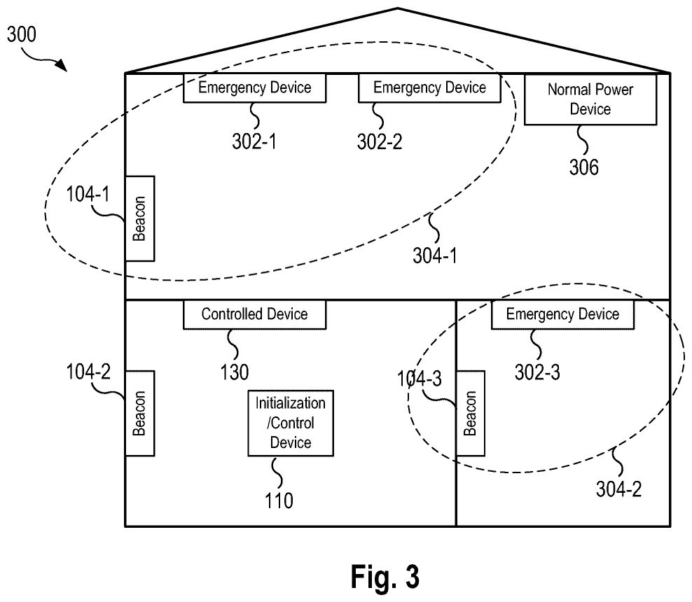

FIG. 3 depicts a schematic diagram of a network system 300 for improved management of target devices, in accordance with some embodiments. Network system 300 can include at least one I/C device 110, emergency beacon device(s) 104, and controlled devices 130 including emergency devices 302 and normal power devices 306. Each component of network system 300 may include a transceiver for communicating with other components in a peer-to-peer, many-to-many control system much like network system 100 described above.

Similar to controlled devices 130 explained above, emergency devices 302 may include two main components, a target emergency device and an adaptor. The target emergency device may be any suitable emergency lighting fixture capable of being controlled and used to illuminate conditions during an emergency state of power loss. For example, the target emergency device may be an emergency lighting fixture in hallways or corridors, or an emergency exit sign illuminating a door or entryway designed as an emergency exit.

In many cases, system 300 is configured to enable the triggering of an emergency mode of operation on specific target devices or groups of target devices, instead of broadcast to the entire network system 300. Network system 300 may include multiple transfer switches (not shown) to manage emergency circuits for different areas or different floors of the building. As such, when normal power is lost in one area of the building, embodiments of the present disclosure enable the triggering of the emergency mode of operation (e.g., UL924 emergency mode) in that particular area only, instead of throughout the entire facility.

In one aspect, emergency beacon device 104 is configured to establish, store, and manage a plurality of associations 304 with other network components or groups of network components. The associations indicate a subset of the total network components in the entire system 300 that a particular emergency beacon device 104 is responsible for triggering emergency modes of operation. In some aspects, emergency beacon device 104 preserves the ability to broadcast its emergency control signals to the entire network and system.

In the example system 300 shown in FIG. 3, I/C device 110 forms an association 304-1 of emergency broadcast beacon 104-1 with a group of devices that includes emergency devices 302-1 and 302-2. I/C device 110 may generate a second association 304-2 that includes emergency broadcast beacon 104-2 and emergency device 302-3. While shown as distinct, it is understood that two or more associations 304 may include overlapping sets of devices or groups of devices. In operation, when emergency beacon device 104-1 detects a loss of power, it will trigger (i.e., via transmitting a short-range communication signal) an emergency signal targeted to the two specific emergency devices 302-1 and 302-2 associated with emergency beacon device 104-1 (e.g., via association 304-1). Any network components in the system 300 that are functional may receive and rebroadcast the emergency signal as part of a short-range mesh networking communications protocol described above. For example, other emergency-enabled devices (e.g., 302-3) powered by emergency power could rebroadcast the emergency signal. In some aspects, in cases where power loss is limited to a particular area of the system 300 (e.g., such as the second floor of a facility), other controlled devices 130 that are still powered (e.g., controlled devices on the first floor) can participate and rebroadcast the emergency signal. In some cases, during this emergency state, some other devices, such as normal power devices 306, may be inactive and unable to participate in the mesh forwarding communications protocol (disabled due to power loss).

According to an aspect of the present disclosure, the I/C devices 110 is configured to manage/configure one or more emergency beacon devices and other network components. A user interacting with a computer program installed on I/C devices 110 may be able to manage individual switches 120, controlled devices 130, and emergency beacon devices 104. In some embodiments, a user may interact with a user interface provided by the computer programs to associate one or more emergency beacon devices with multiple network components or groups of network components. In some aspects, a user may interact with the user interface provided by the computer programs to enable the ability of an emergency beacon device to broadcast its control signals to the entire network.

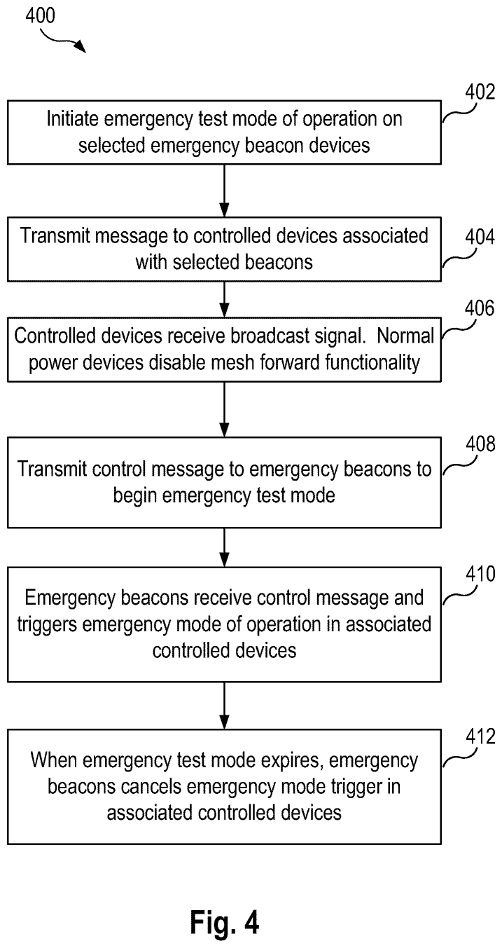

In one aspect, the I/C devices 110 is configured to selectively trigger one or more emergency beacon devices to test the emergency mode operations and configuration for the emergency beacon and its associated network components. The details of triggering an emergency test mode is described in greater detail with respect to FIG. 4.

FIG. 4 shows a flowchart of an illustrative process 400 for implementing an emergency mode of at least one emergency beacon in a network system, in accordance with some embodiments. Process 400 can begin at step 400 in which a network system (e.g., network system 100) is provided having network components that include at least one I/C device (e.g., at least one of I/C devices 110 of FIG. 1), at least one emergency beacon (e.g., at least one of emergency beacons 104 of FIG. 2), and at least one controlled device (e.g., at least one of controlled devices 130 of FIG. 1). The I/C devices may include any type of computing device capable of communicating with the switch(es) and controlled device(s) using the protocols described herein or any other suitable wired or wireless communications protocol. The switch(es) may be configurable by the I/C device(s) to control the behavior of one or more of the controlled device(s). The controlled device(s) may include any suitable controllable device communicatively coupled to an adaptor (e.g., adaptor 140 of FIG. 2)

At step 402, a user of I/C device 110 may initiate emergency test mode across one or more network components of the network system. In an embodiment, the user selects one or more emergency beacon devices 104 that the user would like to test. In some embodiments, the user may configure an amount of time for executing the emergency test mode (e.g., 1 to 90 minutes).

At step 404, the I/C device 110 initiates a test mode on all controlled devices in the location using a broadcast message. In some embodiments, the I/C device 110 repeatedly transmits (e.g., transmitted three times) the broadcast message indicating the initiation of an emergency test mode of operation to ensure all devices will receive the message. In an embodiment, this message will also indicate the configured time in which the user would like the test to last. In some embodiments, the I/C device transmits the broadcast message addressed to those controlled devices having an association with the selected emergency beacon devices.

At step 406, one or more network components (e.g., controlled devices 130) receive the broadcast signal indicating an emergency test mode of operation. In one embodiment, responsive to receiving the broadcast signal indicating an emergency test mode of operation, normal power devices (i.e., controlled non-emergency fixtures or devices) may disable their mesh message forwarding functionality for at least the specified duration of time. In an embodiment, responsive to receiving the broadcast signal indicating an emergency test mode of operation, an emergency-enabled device (e.g., a controlled device including an emergency fixture) disregards the broadcast signal and continues to enable its mesh message forwarding functionality.

In other words, normal power devices will disable their mesh forwarding functionality, as described above, and emergency-enabled devices may disregard the message and continue to relay mesh messages. Embodiments of the present disclosure provide this selective enabling and disabling of mesh forwarding functionality throughout network components of the network system so as to simulate how a power loss and test the robustness and resilience of the mesh networking communications amongst controlled devices, beacons, adapters, etc.

At step 408, the I/C device 110 triggers the emergency test mode on the user-selected emergency beacon(s) using another control message. In an embodiment, the I/C device 110 blocks the user from making any UL924 configuration changes during the time that the UL924 test mode is enabled. The I/C device 110 may provide a graphical indication of the remaining time period for the emergency test mode, such as a countdown timer.

At step 410, one or more emergency beacon devices 104 receive a control message that indicates the start of an emergency test mode of operation. In response, the one or more emergency beacon devices 104 triggers its UL924 configuration, i.e., by transmitting a control message to one or more controlled devices to enter an emergency mode of operation. As described above, this control message causes the emergency-enabled devices to activate (e.g., turning on emergency lighting fixtures, turning off dimming) for at least a specified period of time. Due to the emergency test mode of operation, certain controlled devices may rebroadcast this control message to trigger the emergency mode of operation, while other controlled devices (e.g., normal power devices) will refrain from rebroadcasting via mesh forwarding. In some embodiments, a retrigger of the emergency test mode of operation received during an active timer will restart the timer (on both the beacon devices and controlled devices).

In an embodiment, the one or more emergency beacon devices 104 transmits a control message (triggering emergency mode) that is addressed to certain controlled devices or groups of controlled devices based on a pre-determined association of the controlled devices/groups and the emergency beacon. In an embodiment, the one or more emergency beacon devices 104 transmit a control message triggering emergency mode that is broadcast to the entire network 100.

At step 412, the one or more emergency beacon device(s) 104 transmits a control message indicating a cancellation of the emergency mode of operation to one or more controlled devices 130. In some embodiments, the cancel message may be transmitted in response to a user selection aborting the test mode. In some embodiments, the cancel message may be transmitted responsive to expiry of the timer.

According to one or more aspects of the present disclosure, the emergency mode functionality of the mesh system of network components can be extended to address “lockdown” scenarios. In such scenarios, the mesh network of sensors and fixtures described herein can be configured and operated to address situations where heightened security awareness is required. For example, system 100 may be configured to operate one or more lighting fixtures to a configured dimming level, where different areas of a facility will require different dimming levels during a lockdown scenario. In another scenario, system 100 may be configured to operate one or more motion sensor(s) with higher frequency to enable building managers to track movement in the facility during the lockdown period.

According to an embodiment, a network system, similar to system 100, includes a lockdown beacon device. The lockdown beacon device is configured to trigger in other network components of the system (i.e., network components) a lockdown mode. In some embodiments, the lockdown beacon device may be configured to use a control input line (CC-In) to trigger or cancel a lockdown mode, for example, when the control input line is high, floating, low, or a pulse. In some embodiments, the lockdown beacon device is configured to enable and disable lockdown mode based on a network command (for testing and lockdown scenarios), such as those received from a mesh message via short-range communications protocols described above. When a lockdown mode is enabled at the lockdown beacon device (e.g., via control signal input or via mesh message), the lockdown beacon device will trigger its current lockdown configuration.

The lockdown beacon device is able to configure the amount of time that the beacon device will keep lockdown enabled when triggered (e.g., by input control signals or mesh message). For example, the lockdown beacon device may be configured to set a timer (e.g., 1 to 250 minutes) and upon expiry, cancels the lockdown mode. In another example, the lockdown beacon device may be configured to enable the lockdown mode until explicitly cancelled (i.e., an endless timer). In an embodiment, when the lockdown beacon device receives a retrigger (e.g., another input control signal or mesh message) during an active timer, the lockdown beacon device is configured to restart the lockdown timer.

In one or more embodiments, the I/C devices 110 may manage the lockdown beacon device by configuring one or more associations with other network components, such as controlled devices 130. These associations indicate which subset of controlled devices in the network system have their lockdown mode triggered by a particular lockdown beacon device.

According to an embodiment, controlled devices 130 may be configured to support the use of a lockdown mode of operation, which is triggered by an associated lockdown beacon device. The controlled devices 130 may include target devices such as lighting fixtures and motion sensors. In an embodiment, at least one controlled device 130 may be configured to set a lockdown dim level for the device (e.g., 0-100%), which is a particular dim value for the device (e.g., a lighting fixture) when the lockdown mode is enabled by the associated beacon. In an embodiment, at least one controlled device 130 may be configured to set a motion control time to a different value during a lockdown mode of operation. A default time value will be to keep the motion control value that is configured on the device in normal circumstances. Configurable ranges should match the current motion control time range of 0 to 1800 seconds.

In some embodiments, when the lockdown mode is enabled responsive to the device receiving a lockdown trigger beacon message, in one embodiment, the controlled device may be configured to set dim to a configured lockdown level. In some embodiments, during this lockdown mode, the controlled device may be configured to not allow any dim commands, sensor triggers, or schedule events to alter the configured lockdown dimming level unless that configured lockdown level is set to OFF. In the case where the configured lockdown dim level is set to OFF, only a dimming command (e.g., 0x0A) can alter the dimming value of the device during a lockdown period. In some embodiments, during this lockdown mode, the connected device may be configured to set the motion control timer to the configured lockdown value.

When the lockdown mode is cancelled on the controlled device, the controlled device may be configured to operate the target device to return the dimming output to its last stored dim value before lockdown mode was enabled. In some embodiments, the controlled device may be configured to set the motion control timer back to its value prior to when lockdown mode was enabled. In some embodiments, when lockdown mode is cancelled, the controlled device may be configured to respond to dimming commands, schedule triggers and motion sensors as normal.

According to an aspect of the present disclosure, one or more I/C devices 110 are configured to manage/configure one or more lockdown beacons and other network components, similar to the management of emergency beacons and emergency test modes described above. A user interacting with a computer program installed on I/C devices 110 may be able to manage individual switches 120, controlled devices 130, and lockdown beacon devices. In some embodiments, a user may interact with a user interface provided by the computer programs to associate one or more lockdown beacons with multiple network components or groups of network components. In some aspects, a user may interact with the user interface provided by the computer programs to enable the ability of a lockdown beacon device to broadcast its control signals to the entire network.

In one aspect, the I/C devices 110 is configured to selectively trigger one or more lockdown beacon devices to test the lockdown mode operations and configuration for the lockdown beacon and its associated network components. To trigger this test mode, a user may select one or more lockdown beacon(s) that they would like to test. The user may further select the amount of time they would like the test mode to take place for (e.g., 1-255 minutes). The user may then initiate the lockdown test mode. The I/C device 110 may enable lockdown mode on the user-selected lockdown beacons for the selected amount of time. The I/C device 110 may block the user from making any lockdown configuration changes during the time that the lockdown mode is enabled during the test. The I/C device 110 may further show a countdown timer for this lockdown test.

FIG. 5 shows a flowchart of an illustrative process 500 for implementing a lockdown mode of operation for a network system, in accordance with some embodiments. Process 500 can begin by providing a network system (e.g., network system 100) having network components that include at least one I/C device (e.g., at least one of I/C devices 110 of FIG. 1), at least one lockdown beacon device, and at least one controlled device (e.g., at least one of controlled devices 130 of FIG. 1). The I/C devices may include any type of computing device capable of communicating with the switch(es) and controlled device(s) using the protocols described herein or any other suitable wired or wireless communications protocol. The switch(es) may be configurable by the I/C device(s) to control the behavior of one or more of the controlled device(s). The controlled device(s) may include any suitable controllable device communicatively coupled to an adaptor (e.g., adaptor 140 of FIG. 2)

At step 502, a user of I/C device 110 may initiate lockdown test mode across one or more network components of the network system. In an embodiment, the user selects one or more lockdown beacon devices that the user would like to test. In some embodiments, the user may configure an amount of time for executing the emergency test mode (e.g., 1 to 255 minutes).

At step 504, the I/C device 110 initiates a lockdown test by triggering the user-selected lockdown beacon(s) using a control message. The control message may be transmitted through a line input (e.g., hardwired line), a mesh message (e.g., via short-range communications protocols), or other input signal. In an embodiment, the control message may indicate the configured time that the user would like the lockdown test to last. In an embodiment, the I/C device 110 blocks the user from making any lockdown configuration changes during the time that the lockdown mode is enabled during the test. The I/C device 110 may provide a graphical indication of the remaining time period for the lockdown test mode, such as a countdown timer.

At step 506, one or more lockdown beacon devices receives a control message that indicates the start of a lockdown test mode of operation. In response, the one or more lockdown beacon devices triggers its lockdown configuration, i.e., by transmitting a control message to one or more controlled devices to enter a lockdown mode of operation. As described above, this control message causes the devices to activate for at least a specified period of time, based on a specific mode of operation. For example, a controlled device (e.g., lighting fixture) may set the dim level to a pre-configured lockdown level (e.g., 0-100%). In another example, a controlled device (e.g., a motion sensor) may set a motion control timer to a pre-configured lockdown value. During lockdown mode, the one or more controlled devices may override other command inputs such that no dimming commands, sensor triggers, or scheduled events that might otherwise modify the dimming level can alter the configured lockdown dimming level. The controlled devices may store or retain the existing configuration levels (e.g., dim levels, motion control timer values) in a register or storage device for later use.

Due to the lockdown mode of operation, controlled devices part of the network system 100 may rebroadcast this control message to trigger the lockdown mode of operation. In some embodiments, a retrigger of the lockdown test mode of operation received during an active timer will restart the timer (on both the beacon devices and controlled devices).

In an embodiment, the one or more lockdown beacon devices transmits a control message (triggering lockdown mode) that is addressed to certain controlled devices or groups of controlled devices based on a pre-determined association of the controlled devices/groups and the lockdown beacon. In an embodiment, the one or more lockdown beacon devices transmit a control message triggering lockdown mode that is broadcast to the entire network 100 (and all network components therein).

At step 508, the one or more lockdown beacon device(s) transmits a control message indicating a cancellation of the lockdown mode of operation to one or more controlled devices 130. In some embodiments, the cancel message may be transmitted in response to a user selection aborting the test mode. In some embodiments, the cancel message may be transmitted responsive to expiry of the lockdown timer. Upon disabling lockdown mode, the one or more controlled devices may return its dimming output to a last stored dim value (before lockdown mode was enabled). Upon disable lockdown mode, the controlled devices may set the motion control timer back to what the value was before the lockdown mode was enabled. Upon disabling lockdown mode, the controlled devices may again be responsive to dimming commands, schedule triggers, and motion sensors for dimming and other operations.

It should be noted that the steps of the method described above may be

embodied in computer-readable media stored in a non-transitory computer-readable medium as computer instruction code. The method may include one or more of the steps described herein, which one or more steps may be carried out in any desired order including being carried out simultaneously with one another. For example, two or more of the steps disclosed herein may be combined in a single step and/or one or more of the steps may be carried out as two or more sub-steps. Further, steps not expressly disclosed or inherently present herein may be interspersed with or added to the steps described herein, or may be substituted for one or more of the steps described herein as will be appreciated by a person of ordinary skill in the art having the benefit of the instant disclosure.

As used herein, the term “embodiment” means an embodiment that serves to illustrate by way of example but not limitation.

It will be appreciated to those skilled in the art that the preceding examples and embodiments are exemplary and not limiting to the broad scope of the inventive concepts disclosed herein. It is intended that all modifications, permutations, enhancements, equivalents, and improvements thereto that are apparent to those skilled in the art upon a reading of the specification and a study of the drawings are included within the broad scope of the inventive concepts disclosed herein. It is therefore intended that the following appended claims include all such modifications, permutations, enhancements, equivalents, and improvements falling within the broad scope of the inventive concepts disclosed herein.

What is claimed is:

1. A network system, comprising:
a plurality of network components, including at least one emergency beacon device and a plurality of adapters, each network component comprising:
a transceiver configured to send and receive control signals via a short-range wireless communications protocol;
a memory storing an emergency test mode status;
a central processor configured to execute instructions stored in the memory,
at least one target device communicatively coupled to each adapter of the at least one adaptors, wherein an emergency control signal broadcast from the at least one emergency beacon device is received by each network component within range of the emergency beacon device via the short-range wireless communication protocol and rebroadcast by a first subset of the network components and not rebroadcast by a second subset of the network components.

2. The network system of claim 1, wherein the first subset of network components are UL924-enabled devices.

3. The network system of claim 1, wherein the second subset of network components are normal power devices.

4. The network system of claim 1, wherein the second subset of network components are configured to disable mesh forwarding functionality responsive to receiving an emergency test mode control signal.

5. The network system of claim 1, wherein the second subset of network components are configured to exit emergency test mode based on expiry of a timer.

6. The network system of claim 5, wherein the second subset of network components are configured to restart the timer responsive to receiving a control signal retriggering emergency test mode.

7. The network system of claim 1, wherein the emergency beacon device is configured to, responsive to expiration of a test mode timer, terminate broadcast of the emergency control signal.

8. A method for operating a network system, comprising:
providing the network system, comprising an initialization/control device, an emergency beacon device and a plurality of adaptors, and at least one target device communicatively coupled to each adaptor;
generating and broadcasting, from the initialization/control device, an emergency test control signal to the plurality of adaptors;
determining, by each of the plurality of adaptors, whether the respective adaptor is emergency-enabled;
disabling, by a first subset of the plurality of adaptors, mesh forwarding functionality of the respective adaptor responsive to determining that the respective adaptor is not emergency-enabled;
generating and broadcasting, from the emergency beacon device, an emergency control signal to the plurality of adaptors, wherein the emergency control signal is not rebroadcast by the first subset of adaptors;
responsive to receiving the emergency control signal, by each emergency-enabled adaptor, operating the respective emergency enabled adaptor in an emergency mode of operation.

9. A method for operating a network system, comprising:
providing the network system, comprising an initialization/control device, a lockdown beacon device and a plurality of adaptors, and at least one target device communicatively coupled to each adaptor;
generating and broadcasting, from the lockdown beacon device, a lockdown control signal to the plurality of adaptors; and
responsive to receiving the lockdown control signal, by each adaptor, operating the respective adaptor in a lockdown mode of operation.

10. The method in claim 9, wherein the lockdown mode of operation comprises modifying a dim level of a target device based on a predetermined lockdown level.

11. The method in claim 9, wherein the lockdown mode of operation comprises modifying a motion control timer of a target device based on a predetermined lockdown level.

12. The method in claim 9, wherein the lockdown mode of operation comprises disabling modification of at least one of a dim level and a motion control timer.
